(19) United States
(12) Patent Application Publication
(10) Pub. No.: US 2014/0065480 A1
(43) Pub. Date: Mar. 6, 2014

(54) Positive-Electrode Active Material, Manufacturing Method Of The Same, And Nonaqueous Electrolyte Rechargeable Battery Having The Same

(71) Applicant: DENSO CORPORATION, Kariya-City (JP)

(72) Inventors: Shuhei Yoshida, Tokoname-city (JP); Daisuke Shibata, Tokai-city (JP)

(73) Assignee: DENSO CORPORATION, Kariya-City (JP)

(21) Appl. No.: 14/012,186

(22) Filed: Aug. 28, 2013

(30) Foreign Application Priority Data
Aug. 30, 2012 (JP) 2012-190411

(51) Int. Cl. H01M 4/133; H01M 4/131

(52) U.S. Cl. CPC H01M 4/133; H01M 4/131
USPC 429/220; 429/231.8; 429/224; 429/223; 429/221; 252/182.1

(57) ABSTRACT

A positive-electrode active material for a non-aqueous electrolyte rechargeable battery includes a core portion and a shell portion. The core portion includes at least one of an inorganic oxide having a polyanionic structure and an inorganic compound oxide having a polyanionic structure and including a carbon. The shell portion includes a carbon and covers the core portion. The positive-electrode active material has a property that indicates a continuous pore distribution curve in a graph where a horizontal axis represents a pore diameter and a vertical axis represents a log differentiation pore volume. The positive-electrode active material is manufactured by wet-cracking the inorganic oxide or the inorganic compound oxide with an organic acid solution, and sintering a cracked substance in an inert atmosphere.

### CROSS REFERENCE TO RELATED APPLICATION

This application is based on Japanese Patent Application No. 2012-190411 filed on Aug. 30, 2012, the disclosure of which is incorporated herein by reference.

### TECHNICAL FIELD

The present disclosure relates to a positive-electrode active material for a non-aqueous electrolyte rechargeable (secondary) battery, a method of manufacturing the positive-electrode active material, and a non-aqueous electrolyte rechargeable battery having the positive-electrode active material.

### BACKGROUND

Conventionally, lithium-ion rechargeable batteries, which are characterized by a high energy density, have been used for commercial small instruments, such as a cellular phone and a notebook personal computer. Recently, it has been considered to use the lithium ion rechargeable batteries to large devices, such as a fixed electrically storage system, a hybrid vehicle, and an electric vehicle. To use the lithium ion rechargeable batteries to such large devices, it is required to increase the capacity of the lithium ion rechargeable batteries.

The capacity of the lithium ion rechargeable battery greatly relies on the type of a positive-electrode active material that electrochemically inserts and extracts lithium ion. As the positive-electrode active material, powder of an inorganic oxide, such as LiCoO₂, LiMn₂O₄, or LiFePO₄, is used.

In fact, the capacity, a battery voltage, input-output characteristics, and safety are different depending on the types of positive-electrode active material. Therefore, the positive-electrode active material is used differently depending on the use of the battery. It has been known that a polyanionic positive-electrode active material containing XO₄ tetrahedrons, in which X is P, As, Si, Mo and the like, in its crystal structure is stable.

Among polyanionic positive-electrode active materials, olivine-type positive electrodes (LiMPO₄), such as LiFePO₄ and LiMnPO₄, are excellent in thermal stability. Patent literature 1 teaches to use LiFePO₄ and LiMnPO₄ in the lithium ion rechargeable battery.

However, since the XO₄ tetrahedrons of the polyanionic positive-electrode active material are stable, Li diffusion rate and electronic conductivity of the polyanionic positive-electrode active material are low. To address such an issue, patent literatures 2 and 3 teach to make the positive-electrode active material fine particle and to form a carbon-coating on a surface of the active material.

Also in these positive-electrode active materials, however, a specific surface area increases as the size of the positive-electrode active material particle is reduced, resulting in oxidation of the surface of the positive-electrode active material. An oxide generated on the surface of the active material causes an electric resistance, resulting in degradation of performance of the positive electrode.

For example, it is proposed to form a carbon coating when or after synthesizing a precursor of the active material. However, it is difficult to form a uniform carbon coating that fully covering the surface of the active material. That is, it is difficult to restrict generation of the oxide on the surface of the positive-electrode active material.

Further, manganese phosphate lithium (LiMnPO₄), which is a typical olivine type positive-electrode active material, has a stable crystal structure. Therefore, nuclear growth in the synthesizing is fast and an impure substance (e.g., raw material or side reaction product) made of the oxide is generated on the surface of the active material. As such, it is necessary to remove the impure substance made of the oxide.

In the field of the nonaqueous electrolyte rechargeable battery including not only the lithium ion batteries but also nickel hydride batteries, techniques for removing the oxide from the surface of the active material have been studied. For example, patent literature 4 discloses to remove the oxide by performing an acid treatment.

In the method disclosed in the patent literature 4, the oxide can be removed by the acid treatment. However, because pores are made on the surface of the active material or a carbon material is separated, electric conductivity of the active material is likely to be reduced.

Also, the patent literature 4 discloses to make the active material paste after the acid treatment (washing) without drying. In this case, since the oxide is removed, an activation level of the surface of the active material is high. Therefore, the surface of the active material will be oxidized during the drying of the active material.

In addition, when the active material is made into paste after the acid treatment (washing) without drying, a pH of the paste is low. Therefore, a binder that is added when the active material is made into paste will be degraded due to oxidation or a collector to which the paste is applied will be corroded. Therefore, it is difficult to form the paste.

### PATENT LITERATURES

[Patent Literature 1] U.S. Pat. No. 5,910,382 A

[Patent Literature 2] U.S. Pat. No. 6,962,666 B2

[Patent Literature 3] U.S. Pat. No. 7,457,018 B2

[Patent Literature 4] JP 2009-200013 A

### SUMMARY

The present disclosure is made in view of the foregoing circumstances, and it is an object of the present disclosure to provide a positive-electrode active material for a nonaqueous electrolyte rechargeable battery, which has a core-shell structure capable of reducing an influence of an oxide on a surface of the positive-electrode active material, a method of manufacturing the positive-electrode active material, and a nonaqueous electrolyte rechargeable battery with the positive-electrode active material.

The inventors found that the above object can be achieved by removing the oxide on the surface of the active material and by covering the surface of the active material with a carbon coating.

According to an aspect of the present disclosure, a positive-electrode active material for a non-aqueous electrolyte rechargeable battery has a core-shell structure including a core portion and a shell portion. The core portion includes at least one of an inorganic oxide having a polyanionic structure and an inorganic compound oxide having a polyanionic structure and including a carbon. The shell portion includes a carbon and covers the core portion. Further, the positive-electrode active material has a property that indicates a continuous pore distribution curve in a graph where a horizontal axis represents a pore diameter and a vertical axis represents a log differentiation pore volume.

The positive-electrode active material has the property that indicates the continuous pore distribution curve. Namely, when a pore distribution on the surface of the positive-electrode active material is measured, there is no coarse pore in the shell portion and the core portion is not exposed. As such, in the above positive-electrode active material, the core portion is coated with the shell portion. When the core portion is coated with the shell portion, it is less likely that an oxide will be formed on the surface of the inorganic oxide or the inorganic compound oxide forming the core portion. Therefore, a disadvantage caused by the oxide formed on the surface of the inorganic oxide or the inorganic compound oxide of the core portion will be reduced.

The positive-electrode active material according to the above aspect has the core-shell structure including the core portion and the shell portion. As pores formed on the surface of such a positive-electrode active material, there are two types of pores, one being a fine pore defined in the carbon of the shell portion, and the other being a coarse pore having a larger diameter than the fine pore and provided by a portion where the shell portion is not formed. The core portion is exposed through the coarse pore. That is, if there is the coarse pore, a surface of the inorganic oxide or the inorganic compound oxide of the core portion is exposed and an oxide will be formed on the exposed surface.

In the positive-electrode active material according to the above aspect, the pore distribution curve is a continuous curve in the graph where the horizontal axis represents the pore diameter and the vertical axis represents the log differentiation pore volume. The continuous pore distribution curve indicates a state where only the fine pore is measured, and means that the core portion is fully coated with the shell portion. When the core portion is fully coated, the surface of the inorganic oxide or the inorganic compound oxide of the core portion is not exposed. Therefore, an oxide will not be formed on the surface of the inorganic oxide or the inorganic compound oxide of the core portion.

If a pore distribution curve is not continuous, peaks of the discontinuous pore distribution curve correspond to a pore diameter of the fine pore and a pore diameter of the coarse pore. In such a case, an oxide will be formed on the surface of the core portion.

According to an aspect of the present disclosure, a method of manufacturing a positive-electrode active material includes generating at least one of an inorganic oxide and an inorganic compound oxide, wet-cracking the at least one of the inorganic oxide and the inorganic compound oxide with an organic acid solution, and sintering a cracked substance in an inert atmosphere.

The positive-electrode active material manufactured by the above method has a core-shell structure including a core portion and a shell portion. The core portion includes the at least one of an inorganic oxide with a polyanionic structure and an inorganic compound oxide with a polyanionic structure and including a carbon. The core portion is covered with the shell portion including a carbon. This positive-electrode active material achieves advantageous effects as described above.

The method according to the above aspect provides the advantageous effects not only in a positive-electrode active material having a structure including XO₄, which provides a stable crystal structure, but also a positive-electrode active material having a structure including X₂O₇.

When the positive-electrode active material having the structure described above or manufactured by the method described above is used in a non-aqueous electrolyte rechargeable battery, since an oxide will not be formed on the surface of the inorganic oxide or the inorganic compound oxide of the core portion, an electric resistance is reduced and a battery capacity improves.

### BRIEF DESCRIPTION OF THE DRAWINGS

The above and other objects, features and advantages of the present disclosure will become more apparent from the following detailed description made with reference to the accompanying drawings, in which:

FIG. 1 is a graph illustrating pore distribution curves of a positive-electrode active material of an example and a positive-electrode active material of a comparative example;

FIG. 2 is a diagram illustrating a cross-sectional view of a coin-type battery to which the positive-electrode active material of the example and the comparative example are employed;

FIG. 3 is a graph illustrating measurement results of a battery capacity of the coin-type battery fabricated using the positive-electrode active material of the example and the positive-electrode active material of the comparative example; and

FIG. 4 is a flowchart illustrating a process of manufacturing a positive-electrode active material according to an embodiment.

### DETAILED DESCRIPTION

(Positive-Electrode Active Material for Nonaqueous Electrolyte Rechargeable Battery)

In an embodiment, a positive-electrode active material for a nonaqueous electrolyte rechargeable battery has a core-shell structure including a core portion and a shell portion. The core portion includes at least one of an inorganic oxide having a polyanionic structure and an inorganic compound oxide having a polyanionic structure and including a carbon. The shell portion includes a carbon and covers the core portion. The positive-electrode active material has a property that indicates a continuous pore distribution curve in a graph in which a horizontal axis represents a pore diameter and a vertical axis represents a log differentiation pore volume.

In an embodiment of the positive-electrode active material for a nonaqueous electrolyte rechargeable battery, the inorganic oxide having the polyanionic structure is not limited to a specific one. Also, the inorganic compound oxide having the polyanionic structure and including a carbon is not limited to a specific one.

That is, the inorganic oxide and the inorganic compound oxide exert an effect in a positive-electrode active material having a structure including XO₄, which has a stable crystal structure, and in a positive-electrode active material having a structure including X₂O₇, which has a stable crystal structure.

In an embodiment of the positive-electrode active material for a nonaqueous electrolyte rechargeable battery, the inorganic oxide is LiₓMn_{y}M_{1-y}XO₄, in which M is one or more selected from Co, Ni, Fe, Cu, Cr, Mg, Ca, Zn, and Ti, and X is one or more selected from P, As, Si, and Mo. Also, x satisfies 0≦x<1.0, and y satisfies 0≦y≦1.5.

When the positive-electrode active material having the core portion made of the inorganic oxide with a polyanionic structure expressed by the above chemical formula is used in a non-aqueous electrolyte rechargeable battery, an influence of an oxide on a surface of the inorganic oxide is reduced, and thus the decrease in battery characteristic of the non-aqueous electrolyte rechargeable battery is reduced.

In an embodiment of the positive-electrode active material for a non-aqueous electrolyte rechargeable battery, examples of the inorganic (compound) oxide are LiFePO₄, LiMnPO₄, LiNiPO₄, LiCoPO₄, and Li₂MnP₂O₇, Li₂MnSiO₄.

(Method of Manufacturing Positive-Electrode Active Material For Nonaqueous Electrolyte Rechargeable Battery)

A manufacturing method according to an embodiment is a method of manufacturing a positive-electrode active material for a nonaqueous electrolyte rechargeable battery, having a core-shell structure including a core portion and a shell portion. In the core-shell structure, the core portion includes at least one of an inorganic oxide having a polyanionic structure and an inorganic compound oxide having a polyanionic structure and including a carbon, and the shell portion includes a carbon and covers the core portion. The manufacturing method includes an oxide generating step, a wet-cracking step and a sintering step.

Firstly, the oxide generating step is performed (e.g., S1 in FIG. 4). In the oxide generating step, at least one of the inorganic oxide and the inorganic compound oxide is generated. The inorganic oxide or the inorganic compound oxide generated in the oxide generating step forms the core portion of the core-shell structure of the positive-electrode active material. That is, the inorganic oxide or the inorganic compound oxide is an inorganic oxide or an inorganic compound oxide providing the core portion.

Next, the wet-cracking step is performed (e.g., S2 in FIG. 4). In the wet-cracking step, the inorganic oxide or the inorganic compound oxide generated in the oxide generating step is wet-cracked with an organic acid solution. By the wet-cracking step, an oxide on a surface of the inorganic oxide or the inorganic compound oxide for providing the core portion is removed by a reduction with the organic acid solution. Also, since the inorganic oxide or the inorganic compound oxide is cracked, fine primary particle is formed.

Then, in the sintering step (e.g., S3 in FIG. 4), the cracked substance is sintered in an inert atmosphere. An organic acid contained in the organic acid solution used in the wet-cracking remains on the surface of the cracked substance. Since the cracked substance is sintered (heat-treated) in a state where the inorganic acid adheres to the surface of the cracked substance, the organic acid is carbonated and the surface of the cracked substance (i.e., inorganic oxide particle, inorganic compound oxide particle) is coated. That is, since the cracked substance is sintered (heat-treated) in a state where the organic acid adheres to the cracked substance, the carbon shell portion is formed from the organic acid.

In the manufacturing method, the oxide on the surface of the cracked substance is removed in the wet-cracking step, and the subsequent sintering step is performed in the inert gas atmosphere. Therefore, the carbon shell portion is formed without oxidizing the core portion.

The organic acid is disposed on the surface of the cracked substance in a state of solution. Therefore, the organic acid is disposed on the entire surface of the cracked substance. Further, the sintering is performed in this state. Therefore, the shell portion made of the carbon can be formed on the entire surface of the cracked substance (the inorganic oxide particle, the inorganic compound oxide particle).

Accordingly, in the positive-electrode active material manufactured by the manufacturing method described above, the core portion is entirely covered with the shell portion. It is less likely that an oxide will be formed on the surface of the inorganic oxide or the inorganic compound oxide providing the core portion.

In the oxide generating step, at least one of the inorganic oxide and the inorganic compound oxide having the polyanionic structure is generated. A method of the oxide generating step is not limited to a specific method as long as the inorganic oxide or the inorganic compound oxide forming the core portion can be generated. For example, the inorganic oxide or the inorganic compound oxide is preferably generated by a hydrothermal synthesis method that enables synthesis in a short time. The inorganic oxide or the inorganic compound oxide generated by the oxide generating step may have the carbon shell portion.

In the wet-cracking step, the oxide on the surface of the inorganic oxide or the inorganic compound oxide is removed with the organic acid solution as well as the wet-cracking is performed. A method of the wet-cracking step is not limited to a specific method as long as the oxide is removed and the wet-cracking is performed.

In an embodiment, it is preferable that a pH of the organic acid solution is adjusted to a range from 2 to 4. Since the pH of the Organic acid solution is adjusted to the range from 2 to 4, the oxide on the surface of the inorganic oxide or the inorganic compound oxide can be removed.

When the pH of the organic acid solution is lower than 2, acid is too strong, and a portion other than the oxide on the surface of the inorganic oxide or the inorganic compound oxide will be solved to the organic acid solution. In particular, pitting corrosion will occur in the inorganic oxide or the inorganic compound oxide.

When the pH of the organic acid is greater than 4, it is difficult to remove the oxide. Therefore, the oxide will remain on the positive-electrode active material manufactured.

The organic acid of the organic acid solution is not limited to a specific one.

In regard to the organic acid solution, it is preferable that the organic acid is water-soluble and forms a chelate complex with a transition metal when being thermally loaded. Since the organic acid forms the chelate complex with the transition metal when being thermally loaded, the organic acid is properly adhered to the surface of the cracked substance (the inorganic oxide particle, the inorganic compound oxide particle) during the sintering. That is, the positive-electrode active material in which the core portion is fully coated with the carbon shell portion made from the organic acid can be produced.

Examples of a chelate ligand that forms the chelate complex with the transition metal in the thermally loaded state are chain ligands, such as ethylenediamine, bipyridine, ethylenediaminetetraacetic acid, and phenanthroline, and annular ligands, such as porphyrin and crown ether.

The organic acid of the organic acid solution preferably includes at least one functional group selected from carboxyl group, sulfone group, thiol group, and enol group. When the organic acid includes at least one of these functional groups, the organic acid adheres to the surface of the cracked substance (the inorganic oxide particle, the inorganic compound oxide particle).

The organic acid of the organic acid solution is preferably a polyvalent carboxylic acid. When the organic acid is the polyvalent carboxylic acid, the organic acid adheres to the surface of the cracked substance (the inorganic oxide particle, the inorganic compound oxide particle). The polyvalent carboxylic acid includes at least two carboxyl groups in a molecule. Examples of the polyvalent carboxylic acid are citric acid, ascorbic acid, malic acid, lactic acid, succinic acid, fumaric acid, maleic acid, malonic acid, adipic acid, terephthalic acid, isophthalic acid, sebacic acid, dodecanedioic acid, diphenyl ether-4,4′-dicarboxylic acid, pyridine-2,6-dicarboxylic acid, butane-1,2,4-tricarboxylic acid, cyclohexane-1,2,3-tricarboxylic acid, benzene-1,2,4-tricarboxylic acid, naphthalene-1,2,4-tricarboxylic acid, butane-1,2,3,4-tetracarboxylic acid, cyclobutane-1,2,3,4-tetracarboxylic acid, benzene-1,2,4,5-tetracarboxylic acid, 3,3′,4,4′-benzophenone tetracarboxylic acid, and 3,3′,4,4′-diphenyl ether tetracarboxylic acid.

The concentration of the organic acid of the organic acid solution is not limited to a specific concentration. The concentration of the organic acid can be suitably determined according to the type of the organic acid to be used and the type of the cracked substance (the inorganic oxide particle, the inorganic compound oxide particle).

The organic acid solution may contain another carbon raw material other than the organic acid, as the carbon raw material for forming the shell portion. As the another carbon raw material, a raw material that is used as a carbon raw material for forming a shell portion in a conventional core-shell portion can be used. Examples of the another carbon raw material are organic compounds, such as sucrose, carboxyl methyl cellulose (CMC), polyethylene oxide (PEO), and 1-ascorbic acid.

In the sintering step, the cracked substance (the inorganic oxide particle, the inorganic compound oxide particle) is sintered in a state where the organic acid is adhered to the surface of the cracked substance (the inorganic oxide particle, the inorganic compound oxide particle), so that the shell portion is made from the organic acid adhered. The sintering step is not limited to a specific method as long as the shell portion made of this carbon can be formed.

The sintering temperature is not limited to a specific temperature as long as the carbon shell portion can be formed.

The sintering in the inert atmosphere is preferably provided by a heat treatment at a temperature in a range from 550 degrees Celsius to 650 degrees Celsius. In this case, even if the sintering is performed at the temperature from 550 degrees Celsius to 650 degrees Celsius, which is lower than a conventional sintering temperature, the carbon shell portion can be formed.

The inert gas providing the inert atmosphere for the sintering is not limited to a particular gas as long as the inert gas does not react with the cracked substance (the inorganic oxide particle, the inorganic compound oxide particle). Examples of the inert as are argon, helium, and nitrogen.

The sintering time is not limited to a specific time as long as the carbon shell portion can be formed.

(Non-Aqueous Electrolyte Rechargeable Battery)

A non-aqueous electrolyte rechargeable battery according to an embodiment is provided by using a positive-electrode active material described above or produced by the method described above.

The non-aqueous electrolyte rechargeable battery is not limited to a specific one as long as the positive-electrode active material described above or produced by the method described above is used. In an embodiment, the non-aqueous electrolyte rechargeable battery is preferably a lithium ion rechargeable battery.

The non-aqueous electrolyte rechargeable battery may have a similar structure to a conventional non-aqueous electrolyte rechargeable battery, except that the positive-electrode active material described above or produced by the method described above is used at least. The non-aqueous electrolyte rechargeable battery may include a positive electrode, a negative electrode, an electrolytic solution, and any other necessary member.

The positive electrode is formed in a following manner. The positive-electrode active material described above, a binder, a conductivity assistant and the like are mixed in a solvent such as water or NMP. Then, the mixture is applied on a collector made of a metal such as aluminum.

The binder is preferably made of a polymeric material. The binder is preferably made of a material that is chemically and physically stable in an atmosphere of the rechargeable battery.

Examples of the binder are polyvinylidene fluoride, polytetrafluoroethylene, EPDM, SBR, NBR, and fluororubber. Examples of the conductivity assistant are ketjen black, acetylene black, carbon black, graphite, carbon nanotube, and amorphous carbon. As further examples, the conductivity assistant may be conductive polymer polyaniline, polypyrrole, polythiophene, polyacethylene, polyacene, or the like.

A metal oxide, such as a lithium containing transition metal oxide, can be added to the positive-electrode active material. Examples of the metal oxide are LiCoO₂, LiNiO₂, and LiMn₂O₄.

A negative-electrode active material can be provided by one of or combination of compounds that occlude and discharge lithium ion. Examples of the compound that can occlude and discharge the lithium ion are a metal material, such as lithium, an alloy material containing silicon, tin, or the like, a carbon material, such as graphite, coke, an organic high polymer compound sintered substance, and amorphous carbon. These active materials may be used solely or in any combination.

For example, a lithium metal foil is used as the negative-electrode active material. In this case, the negative electrode may be formed by bonding the lithium metal foil on a surface of a collector made of a metal such as copper. For example, an alloy material or a carbon material is used as the negative-electrode active material. In this case, the negative electrode is formed in a following manner. A negative-electrode active material, a binder, a conductivity assistant and the like are mixed in a solvent such as water or NMP. Then, the mixture is applied on a surface of a collector made of a metal such as copper.

The binder is preferably made of a polymeric material. The binder is preferably a material that is chemically and physically stable in the atmosphere of the rechargeable battery.

Examples of the binder are polyvinylidene fluoride (PVDF), polytetrafluoroethylene (PTFE), ethylene-propylene-diene copolymer (EPDM), styrene butadiene rubber (SBR), acrylonitrile-butadiene rubber (NBR), and fluororubber. Examples of the conductivity assistant are ketjen black, acetylene black, carbon black, graphite, carbon nanotube, and amorphous carbon. As further examples, the conductivity assistant may be provided by conductive polymer polyaniline, polypyrrole, polythiophene, polyacethylene, polyacene, or the like.

An electrolyte is a medium that conveys charge carriers, such as ion between the positive electrode and the negative electrode. The electrolyte is not limited to a specific one, but is preferably an electrolyte that is physically, chemically and electrically stable in the atmosphere where the non-aqueous electrolyte rechargeable battery is used.

The electrolyte is preferably an electrolyte solution provided by solving a supporting electrolyte in an organic solvent. The supporting electrolyte may be one or more selected from LiBF₄, LiPF₆, LiCF₃SO₃, LiN(CF₃SO₂)₂, LiN(C₂F₅SO₂)₂, and LiN(CF₃SO₂) (C₄F₉SO₂).

The organic solvent may be one of or any combination of propylene carbonate (PC), ethylene carbonate (EC), 1,2-dimethoxyethane (DME), dimethyl carbonate (DMC), diethyl carbonate (DEC), ethylmethyl carbonate (EMC), tetrahydrofuran (THF), 2-methyltetrahydrofuran, tetrahydropyran, and the like. In particular, the electrolyte solution containing a carbonate-based solvent has excellent stability in high temperature, and is preferable. Also, a solid polymeric electrolyte containing the above electrolyte in a solid polymer, such as polyethylene oxide, may be used. Further, another solid electrolyte, such as a ceramic having a lithium ion conductivity and a glass, may be used.

A separator is preferably disposed between the positive electrode and the negative electrode to provide electric insulation and ion conductivity between the positive electrode and the negative electrode. In a case where the electrolyte is in a liquid state, the separator serves to hold the liquid electrolyte. Examples of the separator are a porous synthetic resin film, in particular, a polyolefine-based macromolecule, such as polyethylene or polypropylene, a porous membrane made of glass fiber, and nonwoven fabric. It is preferable to employ a separator with a size greater than the positive electrode and the negative electrode so as to provide electric insulation between the positive electrode and the negative electrode.

The positive electrode, the negative electrode, the electrolyte, and the separator are generally housed in a case. The case is not limited to a specific one. The case may be made of a known material, and may have a known shape. That is, the shape of the non-aqueous electrolyte rechargeable battery is not limited to a specific shape, and the non-aqueous electrolyte rechargeable battery of the present disclosure may have any shape, such as a coin shape, a cylindrical shape, or a square shape.

Also, the shape and the material of the case of the non-aqueous electrolyte rechargeable battery are not limited to specific shape and material. The case may be made of a metal or a resin. The case may be a soft case, such as a laminated package, that can maintain its outer shape.

### EXAMPLES

Hereinafter, the present disclosure will be described more in detail with reference to examples in which the present disclosure is employed as a lithium ion rechargeable battery.

### Examples 1-4

1.5 mol of LiOH.H₂O and 1 mol of (NH₄)₂HPO₄ were weighted. Also, MnSO₄.5H₂O and Fe(NO₃)₃.9H₂O are weighted such that the total of Mn and Fe is 1 mol. Each raw material weighted was mixed to a ultrapure water to prepare a raw material solution.

The raw material solutions were selected and put into a heat-resistant container (capacity: 100 cm³) to have a composition shown in a table 1. The raw material solutions were added in an order of Li solution, P solution, Mn solution, and Fe solution. After these raw material solutions were added, a CMC solution was added to the mixed solution such that a solid content becomes 0.86%.

The mixed solution was agitated for 10 minutes at the room temperature under nitrogen gas circulation.

After the agitation, the mixed solution was held for 3 hours at 200 degrees Celsius to generate a precursor of the inorganic oxide by a hydrothermal synthesis.

The precursor of the inorganic oxide generated was powder-washed by centrifugal separation, filtered, and dried for 10 hours at 80 degrees Celsius under a vacuum condition.

After the drying, the precursor of the inorganic oxide was heat-treated for 1 hour at 700 degrees Celsius in an argon gas atmosphere containing 3% of hydrogen gas. As a result, the inorganic oxide with the core-shell structure was generated.

An organic acid solution was prepared by using an organic acid shown in the table 1. The organic acid was added such that a pH of the solution becomes the value shown in the table 1.

The organic acid solution prepared was put in a ball grinder with the inorganic oxide having the core-shell structure, and cracked for 10 minutes at 4000 rpm. After the cracking, an average particle diameter d50 of the inorganic oxide was 5 micrometers to 15 micrometers.

The inorganic oxide with the core-shell structure after the cracking was heat-treated for 5 hours at 600 degrees Celsius under an argon gas atmosphere containing 3% of hydrogen gas. In this way, the positive-electrode active materials of examples 1 to 4 were produced.

TABLE 1

| | | Carbon | Organic Acid Solution | | Pore Distribution | ⅕ C Capacity |
|---|---|---|---|---|---|---|
| | Composition | Coating | Organic Acid | pH | Curve | (mAh/g) |
| Ex. 1 | LiFePO₄ | Yes | Citric Acid | 2.1 | Continuous | 158 |
| Ex. 2 | LiFePO₄ | Yes | Citric Acid | 4.0 | Continuous | 150 |
| Ex. 3 | LiFePO₄ | Yes | Citric Acid + Ni(NO₃)₂ | 2.1 | Continuous | 163 |
| Ex. 4 | LiMnPO₄ | Yes | Citric Acid | 2.1 | Continuous | 100 |
| Comp. Ex. 1 | LiFePO₄ | No | | | Discontinuous | 129 |
| Comp. Ex. 2 | LiFePO₄ | Yes | | | Discontinuous | 140 |
| Comp. Ex. 3 | LiMn_{0.7}Fe_{0.3}PO₄ | Yes | | | Discontinuous | 124 |
| Comp. Ex. 4 | LiMnPO₄ | Yes | | | Discontinuous | 51 |
| Comp. Ex. 5 | LiFePO₄ | Yes | | 8.5 | Discontinuous | 138 |

### Comparative Example 1

An inorganic oxide was produced in a similar manner to the examples 1 to 4, except that Li solution, P solution and Fe solution were selected from the raw material solutions, and a CMC was not added.

Then inorganic oxide produced was cracked and heat-treated in the similar manner to the examples 1 to 4, except that an organic acid was not added.

In this way, a positive-electrode active material (LiFePO₄) of the comparative example 1 was produced.

### Comparative Examples 2-4

Positive-electrode active materials with a core-shell structure of comparative examples 2-4 were produced in the similar manner to the examples 1-4, except that an organic acid was not added when the crushing is performed.

### Comparative Example 5

A positive-electrode active material with a core-shell structure of a comparative example 5 was produced in a similar manner to the examples 1 to 4, except that 0.86% CMC solution was used, in place of an organic acid when the cracking is performed.

(Evaluation)

To evaluate the positive-electrode active materials produced, a pore distribution of each example 1 to 4 and each comparative example 1 to 5 was measured.

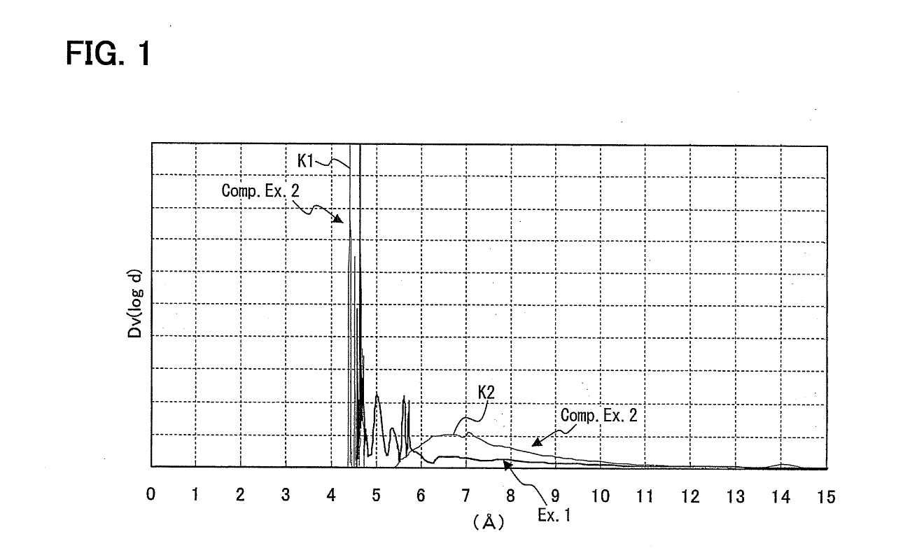

The pore distribution was measured by a gas adsorption method. The measurement result of the positive-electrode active material of the example 1 and the measurement result of the positive-electrode active material of the comparative example 2 are shown as pore diameter distribution curves in a graph of FIG. 1. In the graph of FIG. 1, a horizontal axis represents a pore diameter, and a vertical axis represents a log differentiation pore volume. In the graph of FIG. 1, a thick line denotes the pore diameter distribution curve of the example 1, and a thin line denotes the pore diameter distribution curve of the comparative example 2.

Also, an observation result of the pore distribution of the positive-electrode active material of each of the examples 1 to 4 and comparative examples 1 to 5 is shown in the table 1. In the table 1, “continuous” means that the pore distribution curve is continuous, and “discontinuous” means that the pore distribution curve is not continuous, that is, separated.

As shown in FIG. 1, in regard to the positive-electrode active material of the example 1, the pore distribution curve rises in a range from 4 Å to 5 Å, and has a plurality of peaks in a range lower than 6 Å. The pore distribution curve does not have peaks in a range from 6 Å or more. That is, it is appreciated that the pore distribution curve of the positive-electrode active material of the example 1 is continuous.

In regard to the positive-electrode active material of the comparative example 2, the pore distribution curve has a plurality of peaks including a maximum point K1 in a range from 4 Å to 5 Å. The pore distribution curve drops to zero around 5 Å, and rises in a range from 5 Å to 6 Å. Further, the pore distribution curve has a peak around 7 Å, as shown by a maximum point K2. In this way, it is appreciated that the pore distribution curve of the positive-electrode active material of the comparative example 2 is not continuous.

As shown in FIG. 1, it is appreciated that the pore distribution curve of the comparative example 2 is not continuous, and two peaks shown by the maximum point K1 and the maximum point K2 are not continuous, i.e., separated. That is, it is appreciated that the positive-electrode active material of the comparative example 2 has two types of pores, one being a fine pore corresponding to the peak shown by the maximum point K1, and the other being a coarse pore corresponding to the peak shown by the maximum point K2. The positive-electrode active material (LiFePO₄) of the comparative example 2 has a core-shell structure including a carbon coating. The fine pore is defined in the carbon itself of the shell portion covering the core portion. The coarse pore is caused by pore provided as the carbon of the shell portion is formed discontinuous. That is, in the positive-electrode active material of the comparative example 2, the carbon coating is formed unevenly. In other words, the shell portion is not formed uniform.

In regard to the positive-electrode active material of the example 1, the pore distribution curve is continuous. It is appreciated that the positive-electrode active material of the example 1 does not have the coarse pore. That is, it is appreciated that the positive-electrode active material of the example 1 has a uniform carbon coating. In other words, the shell portion is evenly formed.

As shown in the table 1, the pore distribution curves of the examples 2 to 4 are continuous, similar to that of the example 1. It is appreciated that the positive-electrode active materials of the examples 2 to 4 do not have the coarse pore. That is, it is appreciated that the positive-electrode active materials of the examples 2 to 4 have a uniform carbon coating. In other words, the shell portion is evenly formed.

The positive-electrode active materials of the comparative examples 3-5 do not have a uniform carbon coating, i.e., the shell portion is not evenly formed, similar to the comparative example 2.

(Coin-Type Lithium Ion Rechargeable Battery)

A coin-type lithium ion rechargeable battery was fabricated using the positive-electrode active material of each of the examples 1 to 4 and comparative examples 1 to 5.

(Fabrication of Coin-Type Lithium Ion Rechargeable Battery)

To prepare a positive-electrode active material paste, the positive-electrode active material powder produced, acetylene black as an electric conducting agent, and PVDF as a binder were weighted to have a mass ratio of 85:50:10, and mixed in an agate mortar.

The positive-electrode active material paste prepared was applied on a collector 1a and dried in a vacuum. Thus, a positive electrode 1 having 0.18 mg/mm², 2.0 g/cm³ of positive-electrode active material layer 1b on a surface was produced. In this case, the collector 1a is made of an aluminum foil with a thickness of 5 micrometers (μm) and a size of 15 mm².

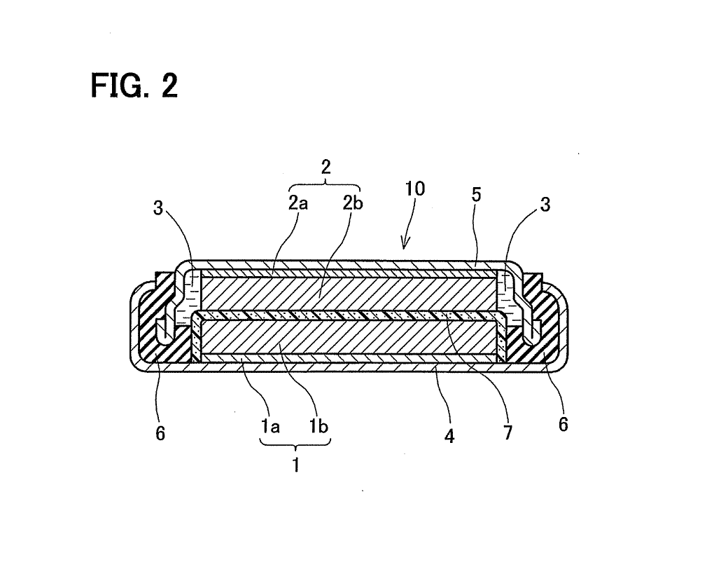

FIG. 2 is a diagram illustrating a cross-sectional view of a coin-type lithium ion rechargeable battery 10 produced. As the positive electrode 1, the positive electrode produced above was used. In the negative electrode 2, a lithium metal was used as an active material. The negative electrode 2 includes a negative electrode collector 2a and a negative-electrode active material 2b that is made of the lithium metal and integrated to the surface of the negative electrode collector 2a. As an electrolyte, a non-aqueous electrolyte solution 3 was used. The non-aqueous electrolyte solution 3 was prepared by adding LiPF₆ to an organic solvent such that the content of the LiPF₆ is 10 mass %. The organic solvent was prepared by mixing EC, DMC and EMC with a volume ratio of 3:3:4. In the non-aqueous electrolyte solution 3, vinylene carbonate (VC) and lithium bis (trifluoromethane sulfonyl) imide (LiTFSI) were added as an additive agent such that the content of VC is 2 mass % and the content of LiTFSI is 0.5 mass %.

Further, an electric generation element in which a separator 7 is disposed between the positive electrode and the negative electrode is housed in a stainless case together with the above-described non-aqueous electrolyte solution. In this way, the coin-type lithium ion rechargeable battery 10 was produced.

For example, the separator 7 is a porous membrane made of polyethylene. The case is constructed of a positive-electrode case 4 and a negative-electrode case 5. The positive-electrode case 4 serves as a positive-electrode terminal. The negative-electrode case 5 serves as a negative-electrode terminal. A gasket 6 made of polypropylene was disposed between the positive-electrode case 4 and the negative-electrode case 5 to seal and electrically insulate between the positive-electrode case 4 and the negative-electrode case 5.

An initial charging and discharging was performed to the coin-type lithium ion rechargeable battery 10 produced. The initial charging and discharging was performed in a range from 2.0 V to 4.5 V at a ⅓ current rate of a battery capacity (⅓×C), and was repeated for two cycles.

(Evaluation of Coin-Type Battery)

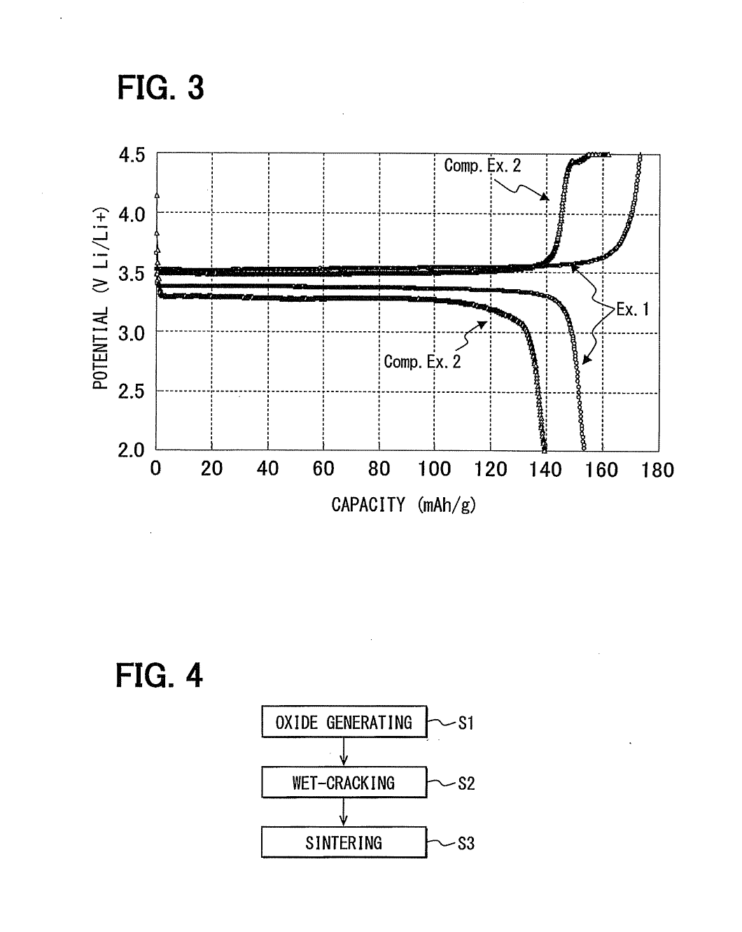

A charging and discharging was performed to the coin-type lithium ion rechargeable battery 10 produced. The charging and discharging was performed in a range from 2.0 V to 4.5 V at 1/10 current rate of a battery capacity ( 1/10×C), and the battery capacity at that time was measured. FIG. 3 is a graph illustrating measurement results of the battery capacity of the coin-type lithium ion rechargeable battery 10 using the positive-electrode active material of each of the example 1 and the comparative example 2. Also, the measurement result of the battery capacity of the coin-type lithium ion rechargeable battery using each of the examples 1 to 4 and comparative examples 1 to 5 is shown in the table 1.

As shown in FIG. 3 and the table 1, a charging capacity and a discharging capacity of the coin-type lithium ion rechargeable battery of the example 1 are greater than those of the coin-type lithium ion rechargeable battery of the comparative example 2. These two coin-type lithium ion rechargeable batteries are different on a point whether the cracking of the inorganic oxide is performed under the organic acid solution or not during the manufacturing of the positive-electrode active material. That is, it is appreciated that the battery capacity of the coin-type lithium ion rechargeable battery increases when the cracking of the inorganic oxide is performed in the organic acid solution.

It is appreciated that the battery capacity of the coin-type lithium ion rechargeable battery of the examples 1 and 2 is higher than that of the comparative example 5. A difference between the coin-type lithium ion rechargeable battery of the examples 1 and 2 and the coin-type lithium ion rechargeable battery of the comparative example 5 is the pH of the solution when the inorganic oxide is cracked. That is, when the pH of the solution used when the inorganic oxide is cracked is in a range from 2 to 4, the battery capacity of the coin-type lithium ion rechargeable battery improves.

In the coin-type lithium ion rechargeable battery of the comparative example 3, the transition metal element (Ni) is further added to the organic acid solution for the cracking of the inorganic oxide, as compared to the coin-type lithium ion rechargeable battery of the example 1. It is appreciated that the battery capacity of the coin-type lithium ion rechargeable battery further improves by adding the transition metal element.

The battery capacity of the coin-type lithium ion rechargeable battery of the example 1 is approximately 1.1 times the battery capacity of the lithium ion rechargeable battery of the comparative example 2. The battery capacity of the coin-type lithium ion rechargeable battery of the example 4 is approximately 1.1 times the battery capacity of the lithium ion rechargeable battery of the comparative example 4. That is, it is appreciated that the rate of increase of the battery capacity increases when a manganese-based positive-electrode active material is used.

As described above, the battery capacity of the lithium ion rechargeable battery of each example 1 to 4 is greater than that of the lithium ion rechargeable battery of each comparative example 1 to 5. In the examples 1 to 4, the positive-electrode active material is manufactured by performing the wet-cracking in the organic acid solution, and sintering. Therefore, it is appreciated that the positive-electrode active material produced by the method of the present disclosure achieves the effect of increasing the battery capacity. This effect is achieved when the uniform carbon coating is formed on the surface of the core portion and an oxide is not formed on the core portion in the positive-electrode active material with the core -shell structure.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A positive-electrode active material for a non-aqueous electrolyte rechargeable battery, the positive-electrode active material comprising:
a core portion including at least one of an inorganic oxide having a polyanionic structure and an inorganic compound oxide having a polyanionic structure and including a carbon; and
a shell portion including a carbon and covering the core portion, wherein
the positive-electrode active material has a property that indicates a continuous pore distribution curve in a graph where a horizontal axis represents a pore diameter and a vertical axis represents a log differentiation pore volume.

2. The positive-electrode active material according to claim 1, wherein
the inorganic oxide is LiₓMn_{y}M_{1-y}XO₄, in which:
M is one or more selected from a group consisting of Co, Ni, Fe, Cu, Cr, Mg, Ca, Zn, and Ti;
X is one or more selected from a group consisting of P, As, Si, and Mo;
x satisfies 0≦x<1.0; and
y satisfies 0≦y≦1.5.

3. A non-aqueous electrolyte rechargeable battery comprising the positive-electrode active material according to claim 1.

4. A method of manufacturing a positive-electrode active material for a non-aqueous electrolyte rechargeable battery, the positive-electrode active material having a core-shell structure including a core portion and a shell portion, the core portion including at least one of an inorganic oxide having a polyanionic structure and an inorganic compound oxide having a polyanionic structure and including a carbon, the shell portion including a carbon and covering the core portion, the method comprising:
generating the at least one of the inorganic oxide and the inorganic compound oxide;
wet-cracking the at least one of the inorganic oxide and the inorganic compound oxide with an organic acid solution; and
sintering a cracked substance in an inert atmosphere.

5. The method according to claim 4, wherein the organic acid solution has a pH in a range from 2 to 4.

6. The method according to claim 4, wherein an organic acid of the organic acid solution is soluble and forms a chelate complex with a transition metal in a thermally loaded condition.

7. The method according to claim 4, wherein an organic acid of the organic acid solution includes at least one functional group selected from a group consisting of a carboxyl group, a sulfone group, a thiol group, and an enol group.

8. The method according to claim 4, wherein an organic acid of the organic acid solution is a polyvalence carboxylic acid.

9. The method according to claim 4, wherein the sintering in the inert atmosphere is provided by a heat-treatment at a temperature in a range from 550 degrees Celsius to 650 degrees Celsius.

10. The method according to claim 4, wherein
the inorganic oxide is LiₓMn_{y}M_{1-y}XO₄, in which:
M is one or more selected from a group consisting of Co, Ni, Fe, Cu, Cr, Mg, Ca, Zn, and Ti;
X is one or more selected from a group consisting of P, As, Si, and Mo;
x satisfies 0≦x<1.0; and
y satisfies 0≦y≦1.5.

11. A non-aqueous electrolyte rechargeable battery comprising a positive-electrode active material manufactured by the method according to claim 4.
